(19) United States
(12) Patent Application Publication
(10) Pub. No.: US 2022/0413005 A1
(43) Pub. Date: Dec. 29, 2022

(54) METHOD FOR VEHICLE SPEED ESTIMATION USING MULTIPLE GEOMAGNETIC SENSORS

(71) Applicant: Xidian University, Xi'an (CN)

(72) Inventors: Changle LI, Xi'an (CN); Gang Wang, Xi'an (CN); Guoqiang Mao, Xi'an (CN); Yilong Hui, Xi'an (CN); Yuexu Chen, Xi'an (CN); Qingwei Cheng, Xi'an (CN); Runsen He, Xi'an (CN)

(21) Appl. No.: 17/851,225

(22) Filed: Jun. 28, 2022

(30) Foreign Application Priority Data
Jun. 29, 2021 (CN) 202110725027.7

(51) Int. Cl. G01P 3/56

(52) U.S. Cl. CPC G01P 3/56

(57) ABSTRACT

The present disclosure provides a method for vehicle speed estimation using multiple geomagnetic sensors, and mainly solves the problem of low accuracy of vehicle speed estimation in existing single-geomagnetic, dual-geomagnetic and multi-geomagnetic scenarios. There are M vehicle detection modules (1), and the vehicle detection modules are deployed along a roadside at equal intervals and configured to detect processes that a vehicle approaches and leaves a detection point, record the time when the vehicle approaches the detection point and send time data to a data processing module (2). In order to avoid the situation that the vehicle detection modules do not detect the vehicle and may not perform, vehicle speed estimation, the data processing module (2) performs matching of data association on the time data uploaded by all the vehicle detection modules by using standard deviations of vehicle position estimation and speed estimation, and performs multiple Kalman filter iterations on the matched time data and the positions of the vehicle detection modules, so as to obtain a precise vehicle speed. The present disclosure improves the accuracy of vehicle speed estimation, and may be used for intelligent transportation management.

### TECHNICAL FIELD

The present disclosure belongs to the technical field of intelligent transportation, and further relates to a system and method for vehicle speed estimation, which may be used for intelligent transportation management.

### BACKGROUND

Intelligent transportation systems have developed rapidly over the past few decades. The intelligent transportation systems mainly aim to improve the safety, efficiency and cost-effectiveness of transportation systems. Through various transportation sensors, such as lidars, microwave sensors, and geomagnetic sensors, transportation monitoring provides valuable transportation flow information for the intelligent transportation systems. Transportation monitoring information may be used by the intelligent transportation systems to improve transportation management.

Fine-grained monitoring of a vehicle speed plays an important role in the intelligent transportation systems. For transportation data acquisition, many transportation monitoring technologies, such as induction loops and video-based image processing methods, are introduced and studied. Especially in urban areas with complex environments, the perception and estimation of transportation conditions require precise vehicle speed data. Methods for vehicle speed estimation mostly rely on microwave radars, optical sensors, geomagnetic sensors, etc. The installation and debugging requirements of the microwave radars are too high, which is not conducive to large-scale deployment. The optical sensors have high requirements on the environment, so the effect of speed estimation will be affected when the weather is bad, such as there is haze. Methods used in related papers and patents for vehicle speed estimation using the geomagnetic sensors are mostly to divide the length of a vehicle by the time for the vehicle to pass through the sensor in a single-geomagnetic-sensor scenario and divide the distance between two sensors by the time for the vehicle to pass through the two sensors in a dual-geomagnetic-sensor scenario. For example, Liu Xiangdong et al. proposed “a method and device for vehicle speed measurement based on a single geomagnetic detector” in the patent, application, with the publication number CN108091144A. This method calculates, the speed of a target vehicle through the time length and physical distance between a peak and a trough in a Y-axis smooth waveform curve. However, due to the uneven, distribution of the magnetic substance content of different vehicles, the real physical distance between the peak and the trough on a Y-axis may not be accurately obtained, and the accuracy of speed estimation is lower. In the paper “Portable Roadside Sensors for Vehicle Counting, Classification, and Speed Measurement”, Saber Taghvaeeyan et al. proposed a method for estimating a vehicle speed based on a distance between sensors. This method sets a fixed distance between two sensors, the time for a vehicle to pass through the two sensors is obtained by calculating a cross-correlation function of magnetic signals of the two sensors passed by the vehicle, and then the distance between the sensors is divided by the time to obtain the vehicle speed. But due to the influence of environmental noise, the magnetic signals of the two sensors passed by the vehicle fluctuate greatly, and the cross-correlation time is difficult to obtain accurately, so the accuracy of speed estimation is also lower.

### SUMMARY

In view of the above deficiencies in the prior art, an objective of the present disclosure is to provide a method for vehicle speed estimation using multiple geomagnetic sensors, so as to improve the accuracy of speed measurement and promote the intelligent development of highways.

To achieve the above objective, the present disclosure adopts the following technical solution:

1. A method for vehicle speed estimation using multiple geomagnetic sensors, including the following steps:

A) enabling a vehicle running on a road to pass through all vehicle detection modules (1) in sequence, wherein there are M vehicle detection modules (1), and the Vehicle detection modules are deployed along a roadside at equal intervals;

B) acquiring, by a data processing module (2), real-time data, and sending the real-time data to each of the vehicle detection modules, so as to synchronize the time of all the vehicle detection modules;

C) detecting, by the vehicle detection modules, magnetic field strength data in real time, sampling the magnetic field strength data at a sampling frequency Fₛ to obtain discrete magnetic field strength data, detecting processes that the vehicle approaches and leaves a detection point, according to the discrete magnetic field strength data, recording time data when the vehicle approaches the detection point, and sending the time data to the data processing module;

D) performing, by the data processing module, data cleaning on the time data uploaded by all the vehicle detection modules, and performing matching of data association by using standard deviations of vehicle position estimation and speed estimation:

D1) traversing each piece of the time data, and judging a format of the time data:

if the format of the time data does not conform to a normal time format. deleting the time data directly; and

if the format of the time data conforms to the normal time format, retaining the time data, and until all the time data is traversed, executing the step D2);

D2) setting an initial value k=1 of a loop variable;

D3) opening a time window for the time when the vehicle approaches the k+1ₜₕ vehicle detection module by the time when the vehicle approaches the kₜₕ vehicle detection module according to the following formula:

$$[ {t}_{k} + \frac{Δ {x}_{k}}{{\hat{v}}_{k}} - 3 \frac{\sqrt{2} {σ}_{k , x}}{{( {\hat{v}}_{k} )}^{2}} {σ}_{k , y} , {t}_{k} + \frac{Δ {x}_{k}}{{\hat{v}}_{k}} + 3 \frac{\sqrt{2} {σ}_{k , x}}{{( {\hat{v}}_{k} )}^{2}} {σ}_{k , y} ]$$

wherein tₖ is the time when the vehicle approaches the kₜₕ vehicle detection module, Δxₖ is a distance between the kₜₕ vehicle detection module and the k+1ₜₕ vehicle detection module, \hat{v}ₖ is a speed at which the vehicle approaches the kₜₕ vehicle detection module, and σ_{k,x} and σ_{k,v} are standard deviations of position estimation, and speed estimation of the vehicle approaching the kₜₕ vehicle detection module respectively;

D4) determining the time tₖ₊₁ when the vehicle approaches the k+1ₜₕ vehicle detection module according, to the number of the time data in the above time window:

if there is only one piece of the time data in the time window, taking the time data as the time tₖ₊₁ when the vehicle approaches the k+1ₜₕ vehicle detection module;

if there are multiple pieces of the time data in the time window, arranging the multiple pieces of time data from small to large, and taking the intermediate time data as the time tₖ₊₁ when the vehicle approaches the k+1ₜₕ vehicle detection module; and

if there is no time data in the time window, taking a median of the time window as the time tₖ₊₁ when the vehicle approaches the k+1ₜₕ vehicle detection module; and

D5) judging the loop variable k and the total number M of the vehicle detection modules:

if the loop variable k is less than the total number of the vehicle detection modules, that is, k<M, adding 1 to the loop variable k and returning to the step D3); and

if the loop variable k is equal to the total number of the vehicle detection modules, that is, k=M, ending iterations, so as to obtain the time for the vehicle to pass through all the vehicle detection modules; and

E) performing, by the data processing module, multiple Kalman filter iterations on the matched time data of the vehicle approaching all the vehicle detection modules and the positions of the vehicle detection modules, so as to obtain a precise vehicle speed:

E1) setting an initial value

$${\hat{θ}}_{1 \vert 1} = [ \begin{matrix}0 \\ \frac{{v}_{max}}{2}\end{matrix} ]$$

of a state of the vehicle approaching a first vehicle detection module and an initial value

$${P}_{1 \vert 1} = [ \begin{matrix}1 & 0 \\ 0 & {( \frac{{v}_{max}}{4} )}^{2}\end{matrix} ]$$

of a covariance matrix, setting a maximum number of iterations to be N according to the accuracy of the vehicle speed required for an actual test, and setting the initial value k=1 of the loop variable, wherein vₘₐₓ is a maximum vehicle speed allowed by the road;

E2) predicting a state of the vehicle approaching the k+1ₜₕ vehicle detection module by a state of the vehicle approaching the kₜₕ vehicle detection module:

$${\hat{θ}}_{k + 1 \vert k} = [ \begin{matrix}{\hat{x}}_{k + 1 \vert k} \\ {\hat{v}}_{k + 1 \vert k}\end{matrix} ] = {F}_{k} {\hat{θ}}_{k \vert k}$$

wherein

$${\hat{θ}}_{k \vert k} = [ \begin{matrix}{\hat{x}}_{k} \\ {\hat{v}}_{k}\end{matrix} ]$$

is the state of the vehicle approaching the kₜₕ vehicle detection module, \hat{x}ₖ is an estimated position of the vehicle approaching the kₜₕ vehicle detection module, and \hat{v}ₖ is an estimated speed of the vehicle approaching the kₜₕ vehicle detection module; \hat{θ}_{k+1|k} is a predicted state of the vehicle approaching the k+1ₜₕ vehicle detection module, \hat{x}_{k+1|k} is a predicted position of the vehicle approaching the k+1ₜₕ vehicle detection module, and \hat{v}_{k+1|k} is a predicted speed of the vehicle approaching the k+1ₜₕ vehicle detection module; and

$${F}_{k} = [ \begin{matrix}1 & Δ {t}_{k} \\ 0 & 1\end{matrix} ]$$

is a state transition matrix, and Δtₖ=tₖ₊₁−tₖ is a time difference between the time when the vehicle approaches the kₜₕ vehicle detection module and the time when the vehicle approaches the k+1ₜₕ vehicle detection module;

E3) estimating, by a state prediction result obtained in the step E2) and a real position of the k+1ₜₕ vehicle detection module, a speed of the vehicle approaching the k+1ₜₕ vehicle detection module according to the following formula:

$${\hat{θ}}_{k + 1 \vert k + 1} = [ \begin{matrix}{\hat{x}}_{k + 1} \\ {\hat{v}}_{k + 1}\end{matrix} ] = {\hat{θ}}_{k + 1 \vert k} + {W}_{k + 1} {λ}_{k + 1}$$

wherein \hat{θ}_{k+1|k+1} is a state of the vehicle approaching the k+1ₜₕ vehicle detection module, \hat{x}ₖ₊₁ is an estimated position of the vehicle approaching the k+1ₜₕ vehicle detection module, and \hat{v}ₖ₊₁ is an estimated speed of the vehicle approaching the k+1ₜₕ vehicle detection module; λₖ₊₁=nₖ₊₁−\hat{x}_{k+1|k} is a distance difference between the real position nₖ₊₁ of the k+1ₜₕ vehicle detection module and a predicted position \hat{x}_{k+1|k} of the vehicle approaching the k+1ₜₕ vehicle detection module; and Wₖ₊₁ is a gain of Kalman filtering, with a calculation formula as follows:

Wₖ₊₁=Pₖ₊₁ₖ(hₖ)^{T}(Sₖ₊₁)⁻¹

wherein P_{k+1|k}=FₖP_{k|k}Fₖ^{T}+Qₖ is a state prediction covariance matrix, P_{k|k} is a covariance matrix when the vehicle approaches the k th vehicle detection module, and

$${Q}_{k} = [ \begin{matrix}2 {( {\hat{v}}_{k \vert k} )}^{2} {σ}_{t}^{2} & 0 \\ 0 & {Q}_{v} \vert {t}_{k + 1} - {t}_{k} \vert\end{matrix} ]$$

is a noise covariance matrix; hₖ=[1 0] is an observation matrix provided by the vehicle detection modules; and Sₖ₊₁=hₖP_{k+1|k}(hₖ)^{T}+Rₖ is a measurement covariance matrix provided by the vehicle detection modules, and Rₖ is observation noise of the vehicle detection modules;

E4) updating a covariance matrix when the vehicle approaches the k+1ₜₕ vehicle detection module according to the following formula:

P_{k+1|k+1}=P_{k+1|k}−Wₖ₊₁Sₖ₊₁Wₖ₊₁^{T}

wherein P_{k+1|k+1} is the covariance matrix when the vehicle approaches the k+1ₜₕ vehicle detection module; and

E5) judging the loop variable k and the set maximum number N of iterations:

if the loop variable k is less than the set maximum number of iterations, that is, k<N, adding 1 to the loop variable k and returning to the step E2); and

if the loop variable k is equal to the set maximum number of iterations, that is, k=N, ending the iterations, so as to obtain the vehicle speed.

Compared with the prior art, the present disclosure has the following advantages:

First, in, the present disclosure, the data processing module is configured to acquire the real-time data and send it to each of the vehicle detection modules, sous to synchronize the time of all the vehicle detection modules.

Second, in the present disclosure, there are a plurality of the vehicle detection modules, and the time data uploaded by all the vehicle detection modules is subjected to matching of data association by using the standard deviations of position estimation and speed estimation, which may avoid the situation that the vehicle detection modules do not detect the vehicle and may not, perform vehicle speed estimation in single-geomagnetic, dual-geomagnetic and multi-geomagnetic scenarios for vehicle speed estimation.

Third, the present disclosure may realize continuous speed estimation of the vehicle on the road by performing Kalman filtering on the time data obtained by data association and the positions of the vehicle detection modules, and with the increase of the number of updates of Kalman filtering, the accuracy of speed estimation also becomes higher and higher.

### BRIEF DESCRIPTION OF DRAWINGS

FIG. 1 is a flowchart for implementing a method provided by the present disclosure; and

FIG. 2 is a deployment diagram of a plurality of vehicle detection modules in the present disclosure.

### DETAILED DESCRIPTION OF EMBODIMENTS

The embodiments of the present disclosure are further described below with reference to the accompanying drawings.

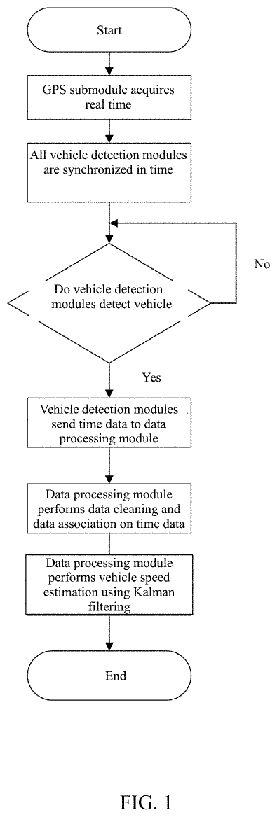

Referring to FIG. 1, a method for vehicle speed estimation using multiple geomagnetic sensors, including the following steps:

step 1: a plurality of vehicle detection modules are deployed according to actual needs, wherein

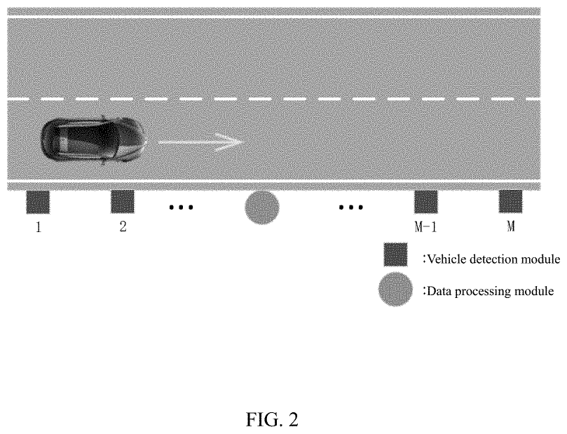

referring to FIG. 2, there are M vehicle detection modules deployed along a roadside at equal intervals, and a vehicle running on a road passes through all the vehicle detection modules in sequence; each of the vehicle detection modules 1 includes a geomagnetic sensor submodule 11, a controller submodule 12, and a data transceiver submodule 13, and the controller submodule 12 is connected with the geomagnetic sensor submodule 11 and the data transceiver submodule 13; the geomagnetic sensor submodule 11 is configured to detect magnetic field strength data in real time and send the magnetic field strength data to the controller submodule 12; the controller submodule 12 is configured to acquire the magnetic field strength data of the geomagnetic sensor submodule and send the time data when the vehicle approaches a detection point to the data transceiver submodule 13; and the data transceiver submodule 13 is configured to send the time data to a data processing module 2;

step 2: the time of all the vehicle detection modules is synchronized, wherein

the data processing module acquires the real-time data and sends it to each of the vehicle detection modules, so as to synchronize the time of all the vehicle detection modules; the data processing module 2 includes a data transceiver submodule 21, a controller submodule 22, and a GPS submodule 23, and the controller submodule 22 is connected with the data transceiver submodule 21 and the GPS submodule 23; the GPS submodule 23 is configured to acquire the real-time data and send the real-time data to each of the vehicle detection modules 1, so as to synchronize the time of all the vehicle detection modules; and the data transceiver submodule 21 is configured to receive the time data uploaded by the vehicle detection modules 1;

step 3: the vehicle detection modules detect the magnetic field strength data in real time, sample the magnetic field strength data at a sampling frequency Fₛ=100 Hz˜500 Hz to obtain discrete magnetic field strength data, detect, processes that the vehicle approaches and leaves the detection point according to the discrete magnetic field strength data, record the time data when the vehicle approaches the detection point, and send the time data to the data processing module:

3.1) the controller submodule 12 sets a threshold Th according to the actually tested magnetic field strength data, and, compares the discrete magnetic field strength data obtained by sampling with the threshold Th, so as to judge the process that the vehicle approaches the detection point:

if the discrete magnetic field strength data is higher than the threshold Th, whether there are K pieces of continuously increased data all higher than the threshold Th subsequently is judged: if yes, it indicates that the vehicle has approached the detection point, the controller submodule 12 records the time data, and the step 3.2) is executed; and if not, it indicates that the data is interference data, and the time data is not recorded; and

if the discrete magnetic field strength data is lower than the threshold Th, it indicates that the vehicle does not approach the detection point, and processing is not performed; and

3.2) the controller submodule 12 compares the above discrete magnetic field strength data with the set threshold Th again, so as to judge the process that the vehicle leaves the detection point:

if the discrete magnetic field strength data is lower than the threshold Th, whether there are L pieces of continuously reduced data all lower than the threshold Th subsequently is judged: if yes, it indicates that the vehicle has left the detection point, the controller submodule 12 sends the time data to the data transceiver submodule 13, and the data transceiver submodule 13 forwards the time data to the data processing module 2; and if not, it indicates that the vehicle has not left a detection range of the sensors; and

if the discrete magnetic field strength data is higher than the threshold Th, it indicates that the vehicle has not left the detection range of the sensors, and a system continues to wait, until the magnetic field strength data is lower than the threshold Th,

wherein, values of K and L are determined according to the actually tested magnetic field strength data;

step 4: the data processing module performs data cleaning on the time data uploaded by all the vehicle detection modules, and performs matching of data association by using standard deviations of vehicle position estimation and speed estimation:

4.1) each piece of the time data is traversed, and a format of the time data is judged:

if the format of the time data does not conform to a normal time format, the time data is deleted directly; and

if the format of the time data conforms to the normal time format, the time data is retained, and until all the time data is traversed, the step 4.2) is executed;

4.2) an initial value k=1 of a loop variable is set;

4.3) a time window is opened for the time when the vehicle approaches the k+1ₜₕ vehicle detection module by the time when the vehicle approaches the kₜₕ vehicle detection module according to the following formula:

$$[ {t}_{k} + \frac{{Δ x}_{k}}{{\hat{v}}_{k}} - 3 \frac{\sqrt{2} {σ}_{k , x}}{{( {\hat{v}}_{k} )}^{2}} {σ}_{k , v} , {t}_{k} + \frac{{Δ x}_{k}}{{\hat{v}}_{k}} + 3 \frac{\sqrt{2} {σ}_{k , x}}{{( {\hat{v}}_{k} )}^{2}} {σ}_{k , v} ]$$

wherein, tₖ is the time when the vehicle approaches the kₜₕ vehicle detection module, Δxₖ is a distance between the kₜₕ vehicle detection module and the k+1ₜₕ vehicle detection module, \hat{v}ₖ is a speed at which the vehicle approaches the k th vehicle detection module, and σ_{k,x} and σ_{k,v} are standard deviations of position estimation, and speed estimation of the vehicle approaching the k th vehicle detection module respectively;

4.4) the time tₖ₊₁ when the vehicle approaches the k+1ₜₕ vehicle detection module is determined according to the number of the time data in the above time window:

if there is only one piece of the time data in the time window, the time data is taken as the time tₖ₊₁ when the vehicle approaches the k+1ₜₕ vehicle detection module;

if there are multiple pieces of the time data in the time window, the multiple pieces of time data are arranged from small to large, and the intermediate time data is taken as the time tₖ₊₁ when the vehicle approaches the k+1ₜₕ vehicle detection module; and

if there is no time data in the time window, a median of the time window is taken as the time tₖ₊₁ when the vehicle approaches the k+1ₜₕ vehicle detection module; and

4.5) the loop variable k and the total number M of the vehicle detection modules are judged:

if the loop variable k is less than the total number of the vehicle detection modules, that is, k<M, 1 is added to the loop variable k and the flow returns to the step 4.3); and

if the loop variable k is equal to the total number of the vehicle detection modules, that is, k=M, iterations are ended, so as to obtain the time for the vehicle to pass through all the vehicle detection modules;

step 5: the data, processing module performs multiple Kalman filter iterations on the matched time data of the vehicle approaching all the vehicle detection modules and the positions of the vehicle detection modules, so as to obtain a precise vehicle speed:

5.1) an initial value

$${\hat{θ}}_{1 \vert 1} = [ \begin{matrix}0 \\ \frac{{v}_{max}}{2}\end{matrix} ]$$

of a state of the vehicle approaching a first vehicle detection module and an initial value

$${P}_{1 \vert 1} = [ \begin{matrix}1 & 0 \\ 0 & {( \frac{{v}_{max}}{4} )}^{2}\end{matrix} ]$$

of a covariance matrix are set, a maximum number of iterations is set to be according to the accuracy of the vehicle speed required for an actual test, and the initial value k=1 of the loop variable is set, wherein vₘₐₓ is a maximum vehicle speed allowed by the road, and this embodiment sets but is not limited to N=7;

5.2) a state of the vehicle approaching the k+1ₜₕ vehicle detection module is predicted by a state of the vehicle approaching the kₜₕ vehicle detection module

$${\hat{θ}}_{k + 1 \vert k} = [ \begin{matrix}{\hat{x}}_{k + 1 \vert k} \\ {\hat{v}}_{k + 1 \vert k}\end{matrix} ] = {F}_{k} {\hat{θ}}_{k \vert k}$$

wherein

$${\hat{θ}}_{k \vert k} = [ \begin{matrix}{\hat{x}}_{k} \\ {\hat{v}}_{k}\end{matrix} ]$$

is the state of the vehicle approaching the kₜₕ vehicle detection module, \hat{x}ₖ is an estimated position of the vehicle approaching the kₜₕ vehicle detection module, and \hat{v}ₖ is an estimated speed of the vehicle approaching the kₜₕ vehicle detection module; \hat{θ}_{k+1|k} is a predicted state of the vehicle approaching the k+1ₜₕ vehicle detection module, is a predicted position of the vehicle approaching the k+1ₜₕ vehicle detection module, and \hat{v}_{k+1|k} is a predicted speed of the vehicle approaching the k+1ₜₕ vehicle detection module; and

$${F}_{k} = [ \begin{matrix}1 & Δ {t}_{k} \\ 0 & 1\end{matrix} ]$$

is a state transition matrix, and Δtₖ=tₖ₊₁−tₖ is a time difference between the time when the vehicle approaches the kₜₕ vehicle detection module and the time when the vehicle approaches the k+1ₜₕ vehicle detection module;

5.3) by a state prediction result obtained in the step 5.2) and a real position of the k+1 th vehicle detection module, a speed of the vehicle approaching the k+1ₜₕ vehicle detection module is estimated according to the following formula:

$${\hat{θ}}_{k + 1 \vert k + 1} = [ \begin{matrix}{\hat{x}}_{k + 1} \\ {\hat{v}}_{k + 1}\end{matrix} ] = {\hat{θ}}_{k + 1 \vert k} + {W}_{k + 1} {λ}_{k + 1}$$

wherein \hat{θ}_{k+1|k+1} is a state of the vehicle approaching the k+1ₜₕ vehicle detection module, \hat{x}ₖ₊₁ is an estimated position of the vehicle approaching the k+1ₜₕ vehicle detection module, and \hat{v}ₖ₊₁ is an estimated speed of the vehicle approaching the k+1ₜₕ vehicle detection module; λₖ₊₁=nₖ₊₁−\hat{x}_{k+1|k} is a distance difference between the real position nₖ₊₁ of the k+1ₜₕ vehicle detection module and a predicted position \hat{x}_{k-1|k} of the vehicle approaching the k+1ₜₕ vehicle detection module; and Wₖ₊₁ is a gain of Kalman filtering, with a calculation formula as follows:

Wₖ₊₁=Pₖ₊₁ₖ(hₖ)^{T}(Sₖ₊₁)⁻¹

wherein P_{k+1|k}=FₖP_{k|k}Fₖ^{T}=Qₖ is a state prediction covariance matrix, P_{k|k} is a covariance matrix when the vehicle approaches the kₜₕ vehicle detection module, and

$${Q}_{k} = [ \begin{matrix}2 {( {\hat{v}}_{k \vert k} )}^{2} {σ}_{t}^{2} & 0 \\ 0 & {Q}_{v} \vert {t}_{k + 1} - {t}_{k} \vert\end{matrix} ]$$

is a noise covariance matrix; hₖ=[1 0]is an observation matrix provided by the vehicle detection modules; and Sₖ₊₁=hₖP_{k+1|k}(hₖ)^{T}=Rₖ is a measurement covariance matrix provided by the vehicle detection modules, and Rₖ is observation noise of the vehicle detection modules:

5.4) a covariance matrix when the vehicle approaches the k+1 th vehicle detection module is updated according to the following formula:

P_{k+1|k+1}=P_{k+1|k}−Wₖ₊₁Sₖ₊₁Wₖ₊₁^{T},

wherein P_{k+1|k+1} is the covariance matrix when the vehicle approaches the k+1ₜₕ vehicle detection module: and

5.5) the loop variable k and the set maximum number N of iterations are judged:

if the loop variable k is less than the set maximum number of iterations, that is, k<N, 1 is added to the loop variable k and the flow returns to the step 5.2); and

if the loop variable k is equal to the set maximum number of iterations, that is, k=N, the iterations are ended, so as to obtain the vehicle speed.

The above is merely a specific embodiment of the present disclosure, and does not constitute any limitation on the present disclosure. Apparently, for those skilled in the art, various modifications and changes in form and detail may be made under the idea and spirit of the present disclosure, but these modifications and changes based on the idea of the present disclosure still fall within the scope of protection of claims of the present disclosure.

1. A method for vehicle speed estimation using multiple geomagnetic sensors, comprising the following steps:
A) enabling a vehicle running on a road to pass through all vehicle detection modules (1) in sequence, wherein there are M vehicle detection modules (1), and the vehicle detection modules are deployed along a roadside at equal intervals;
B) acquiring, by a data processing module (2), real-time data, and sending the real-time data to each of the vehicle detection modules, so as to synchronize the time of all the vehicle detection modules;
C) detecting, by the vehicle detection modules, magnetic field strength data in real time, sampling the magnetic field strength data at a sampling frequency Fₛ to obtain discrete magnetic field strength data, detecting processes that the vehicle approaches and leaves a detection point, according to the discrete magnetic field strength data, recording time data when the vehicle approaches the detection point, and sending the time data to the data processing module;
D) performing, by the data processing module, data cleaning on the time data uploaded by all the vehicle detection modules, and performing matching of data association by using standard deviations of vehicle position estimation and speed estimation:
D1) traversing each piece of the time data, and judging a format of the time data:
if the format of the time data does not conform to a normal time format, deleting the time data directly; and
if the format of the time data conforms to the normal time format, retaining the time data. and until all the time data is traversed, executing the step D2);
D2) setting an initial value k=1 of a loop variable;
D3) opening a time window for the time when the vehicle approaches a k+1ₜₕ vehicle detection module by the time when the vehicle approaches a kₜₕ vehicle detection module according to the following formula:
$$[ {t}_{k} + \frac{Δ {x}_{k}}{{\hat{v}}_{k}} - 3 \frac{\sqrt{2} {σ}_{k , x}}{{( {\hat{v}}_{k} )}^{2}} {σ}_{k , y} , {t}_{k} + \frac{Δ {x}_{k}}{{\hat{v}}_{k}} + 3 \frac{\sqrt{2} {σ}_{k , x}}{{( {\hat{v}}_{k} )}^{2}} {σ}_{k , y} ]$$
wherein tₖ is the time when the vehicle approaches the kₜₕ vehicle detection module, Δxₖ is a distance between the kₜₕ vehicle detection module and the k+1ₜₕ vehicle detection module, \hat{v}ₖ is a speed at which the vehicle approaches the kₜₕ vehicle detection module, and σ_{k,x} and σ_{k,v} are standard deviations of position estimation and speed estimation of the vehicle approaching the k th vehicle detection module respectively;
D4) determining the time tₖ₊₁ when the vehicle approaches the k+1ₜₕ vehicle detection module according to the number of the time data in the above time window:
if there is only one piece of the time data in the time window, takin, the time data as the time tₖ₊₁ when the vehicle approaches the k+1ₜₕ vehicle detection module;
if there are multiple pieces of the time data in the time window, arranging the multiple pieces of time data from small to large, and taking the intermediate time data as the time tₖ₊₁ when the vehicle approaches the k+1ₜₕ vehicle detection module; and
if there is no time data in the time window, taking a median of the time window as the time tₖ₊₁ when the vehicle approaches the k+1ₜₕ vehicle detection module; and
D5) judging the loop variable k and the total number M of the vehicle detection modules:
if the loop variable k is less than the total number of the vehicle detection modules, that is, k<M, adding 1 to the loop variable k and returning to the step D3); and
if the loop variable k is equal to the total number of the vehicle detection modules, that is, k=M ending iterations, so as to obtain the time for the vehicle to pass through all the vehicle detection modules; and
E) performing, by the data processing module, multiple Kalman filter iterations on the matched time data of the vehicle approaching all the vehicle detection modules and the positions of the vehicle detection modules, so as to obtain a precise vehicle speed:
E1) setting an initial value
$${\hat{θ}}_{1 \vert 1} = [ \begin{matrix}0 \\ \frac{{v}_{max}}{2}\end{matrix} ]$$
of, a state of the vehicle approaching a first vehicle detection module and an initial value
$${P}_{1 \vert 1} = [ \begin{matrix}1 & 0 \\ 0 & {( \frac{{v}_{max}}{4} )}^{2}\end{matrix} ]$$
of a covariance matrix, setting a maximum number of iterations to be N according to the accuracy of the vehicle speed required for an actual test, and setting the initial value k=1 of the loop variable, wherein vₘₐₓ is a maximum vehicle speed allowed by the road;
E2) predicting a state of the vehicle approaching the k+1ₜₕ vehicle detection module by a state of the vehicle approaching the kₜₕ vehicle detection module:
$${\hat{θ}}_{k + 1 \vert k} = [ \begin{matrix}{\hat{x}}_{k + 1 \vert k} \\ {\hat{v}}_{k + 1 \vert k}\end{matrix} ] = {F}_{k} {\hat{θ}}_{k \vert k}$$
wherein
$${\hat{θ}}_{k \vert k} = [ \begin{matrix}{\hat{x}}_{k} \\ {\hat{v}}_{k}\end{matrix} ]$$
is the state of the vehicle approaching the kₜₕ vehicle detection module, \hat{x}ₖ is an estimated position of the vehicle approaching the kₜₕ vehicle detection module, and \hat{v}ₖ is an estimated speed of the vehicle approaching the kₜₕ vehicle detection module; \hat{θ}_{k+1|k} is a predicted state of the vehicle approaching the k+1ₜₕ vehicle detection module, \hat{x}_{k+1|k} is a predicted position of the vehicle approaching the k+1ₜₕ vehicle detection module, and \hat{v}_{k+1|k} is a predicted speed of the vehicle approaching the k+1ₜₕ vehicle detection module; and
$${F}_{k} = [ \begin{matrix}1 & Δ {t}_{k} \\ 0 & 1\end{matrix} ]$$
is a state transition matrix, and Δtₖ=tₖ₊₁−tₖ is a time difference between the time when the vehicle approaches the kₜₕ vehicle detection module and the time when the vehicle approaches the k+1ₜₕ vehicle detection module;
E3) estimating, by a state prediction result obtained in the step E2) and a real position of the k+1ₜₕ vehicle detection module, a speed of the vehicle approaching the k+1ₜₕ vehicle detection module according to the following formula:
$${\hat{θ}}_{k + 1 \vert k + 1} = [ \begin{matrix}{\hat{x}}_{k + 1} \\ {\hat{v}}_{k + 1}\end{matrix} ] = {\hat{θ}}_{k + 1 \vert k} + {W}_{k + 1} {λ}_{k + 1}$$
wherein \hat{θ}_{k+1|k+1} is a state of the vehicle approaching the k+1ₜₕ vehicle detection module, \hat{x}ₖ₊₁ is an estimated position of the vehicle approaching the k+1ₜₕ vehicle detection module, \hat{v}ₖ₊₁ is an estimated speed of the vehicle approaching the k+1ₜₕ vehicle detection module; λₖ₊₁=nₖ₊₁−\hat{x}_{k+1|k} is a distance difference between the real position nₖ₊₁ of the k+1ₜₕ vehicle detection module and a predicted position \hat{x}_{k-1|k} of the vehicle approaching the k+1ₜₕ vehicle detection module; and Wₖ₊₁ is a gain of Kalman filtering, with a calculation formula as follows:
Wₖ₊₁=P_{k+1|k}(hₖ)^{T}(Sₖ₊₁)⁻¹
wherein P_{k+1|k}=FₖP_{k|k}Fₖ^{T}+Qₖ is a state prediction covariance matrix, P_{k|k} is a covariance matrix when the vehicle approaches the k th vehicle detection module, and
$${Q}_{k} = [ \begin{matrix}2 {( {\hat{v}}_{k \vert k} )}^{2} {σ}_{t}^{2} & 0 \\ 0 & {Q}_{v} \vert {t}_{k + 1} - {t}_{k} \vert\end{matrix} ]$$
is a noise covariance matrix; hₖ=[1 0]is an observation matrix provided by the vehicle detection modules; and Sₖ₊₁=hₖP_{k+1|k}(hₖ)_{T}+Rₖ is a measurement covariance matrix provided by the vehicle detection modules, and Rₖ is observation noise of the vehicle detection modules;
E4) updating a covariance matrix when the vehicle approaches the k+1ₜₕ vehicle detection module according to the following formula:
P_{k+1|k+1}=P_{k+1|k}−Wₖ₊₁Sₖ₊₁Wₖ₊₁^{T}
wherein P_{k+1|k+1} is the covariance matrix when the vehicle approaches the k+1ₜₕ vehicle detection module; and
E5) judging the loop variable k and the set maximum number N of iterations:
if the loop variable k is less than the set maximum number of iterations, that is, k<N, adding 1 to the loop variable k and returning to the step E2); and
if the loop variable k is equal to the set maximum number of iterations, that is, k=N, ending the iterations, so as to obtain the vehicle speed.

2. The method according to claim 1, wherein in the step A), each of the vehicle detection modules (1) comprises a geomagnetic sensor submodule (11), a controller submodule (12), and a data transceiver submodule (13), and the controller submodule (12) is connected with the geomagnetic sensor submodule (11) and the data transceiver submodule (13); the geomagnetic sensor submodule (11) is configured to detect the magnetic field strength data in real time and send the magnetic field strength data to the controller submodule (12) the controller submodule (12) is configured to acquire the magnetic field strength data of the geomagnetic sensor submodule and send the time data when the vehicle approaches the detection point to the data transceiver submodule (13); and the data transceiver submodule (13) is configured to send the time data to the data processing module (2).

3. The method according to claim 1, wherein in the step B), the data, processing module (2) comprises a data transceiver submodule (21), a controller submodule (22), and a GPS submodule (23), and the controller submodule (22) is connected with the data transceiver submodule (21) and the UPS submodule (23); the GPS subrnodule (23) is configured to acquire the real-time data and send the real-time data, to each of the vehicle detection modules (1), so as to synchronize the time of all the vehicle detection modules; and the data transceiver submodule (21) is configured to receive the time data uploaded by the vehicle detection modules (1).

4. The method according to claim 1, wherein in the step C), the frequency at which the magnetic field strength data is sampled by the vehicle detection modules is set to be 100 Hz˜500 Hz so as to obtain the discrete magnetic field strength data.

5. The method according to claim 1, wherein in the step C), detecting, by the vehicle detection modules, the processes that the vehicle approaches and leaves the detection point according to the discrete magnetic field strength data comprises:
C1) setting a threshold Th according to the actually tested magnetic field strength data;
C2) comparing, by the vehicle detection modules, the discrete magnetic field strength data obtained by sampling with the threshold Th, so as to judge the process that the vehicle approaches the detection point:
if the discrete magnetic field strength data is higher than the threshold Th, judging whether there are K pieces of continuously increased data all higher than the threshold Th subsequently: if yes, indicating, that the vehicle has approached the detection point, recording, by the vehicle detection modules, the time data, and executing the step C3); and if not, indicating that the data is interference data, and skipping recording the time data; and
if the discrete magnetic field strength data is lower than the threshold Th, indicating that the vehicle does not approach the detection point, and skipping performing processing; and
C3) comparing, by the vehicle detection modules, the above discrete magnetic field strength data with the set threshold Th again, so as to judge the process that the vehicle leaves the detection point:
if the discrete magnetic field strength data is lower than the threshold Th, judging whether there are L pieces of continuously reduced data all lower than the threshold Th subsequently: if yes, indicating that the chick has left the detection point; and if not, indicating that the vehicle has not left a detection range of the sensors; and
if the discrete magnetic field strength data is higher than the threshold Th, indicating that the vehicle has not left the detection range of the sensors, and making a system continue to wait, until the magnetic field strength data is lower than the threshold Th,
wherein values of K and L are determined according to the actually tested magnetic field strength data.
